(19) United States
(12) Patent Application Publication
(10) Pub. No.: US 2012/0239465 A1
(43) Pub. Date: Sep. 20, 2012

(54) ALLOCATING REWARDS FROM A REWARDS ACCOUNT

(75) Inventors: Mark McInnes, West Chester, PA (US); Eric Charles Boyd, New London Township, PA (US); Emilie Astrid Cordell, Glenmoore, PA (US); Gary R. Holland, II, West Chester, PA (US); Dimitrij A. Lang, Bedford, TX (US); Gregory Joseph LIoyd, Charlotte, NC (US); Daniel C. Maddox, Cochranville, PA (US); Andrea Robinette, Hockessin, DE (US); Robert L. Rowe, Wills Piont, TX (US); Burton William Schaen, JR., Bear, DE (US); Stephen Mark Schneeweis, Newart, DE (US)

(73) Assignee: BANK OF AMERICA CORPORATION

(21) Appl. No.: 13/155,178

(22) Filed: Jun. 7, 2011

Related U.S. Application Data
(60) Provisional application No. 61/454,494, filed on Mar. 18, 2011.

(51) Int. Cl. G06Q 30/00

(52) U.S. Cl. 705/14.1

(57) ABSTRACT

A method for allocating rewards across a plurality of rewards programs, each associated with one or more accounts owned by a customer, the method includes receiving customer input indicating that one or more rewards associated with a first rewards program should be associated with a second rewards program, determining a conversion factor configured for assisting conversion of the one or more rewards from the first rewards program to the second rewards program, applying, using a processing device, the conversion factor to the one or more rewards, thereby resulting in one or more converted rewards; and associating the one or more converted rewards with the second rewards program.

### CLAIM OF PRIORITY UNDER 35 U.S.C. §119

This Non-provisional Patent Application claims priority to Provisional Patent Application Ser. No. 61/454,494 titled “Customer Awareness Platform” filed Mar. 18, 2011, assigned to the assignee hereof and hereby expressly incorporated by reference herein.

### FIELD

In general, embodiments of the invention relate to systems for providing customer awareness regarding rewards programs. More specifically, embodiments of the invention relate to systems for providing customer awareness regarding rewards programs associated with customer accounts via a single platform or interface.

### BACKGROUND

Various customer rewards programs are available for customers of financial institutions. In some programs, rewards are accumulated based on purchases made via credit and/or debit cards and their associated accounts. The rewards may be accumulated in the form of points that can be redeemed in exchange for an article, service or other prize. In other programs, the rewards may be accumulated in other forms, such as monetary amounts like dollar amounts. In some programs, the rewards may be items representative of some aspect of the program, such as frequent flier miles, which are representative of a rewards program designed for rewarding customers of airlines for frequent use of the airline. In other programs, rewards may be related to and representative of the actual reward. For example, in some rewards programs, the rewards are bases, which are representative of a rewards program designed for customers who are baseball fans. In some such programs, the accumulated bases may be redeemed for tickets to one or more baseball games, baseball merchandise, or other baseball-related prize.

A customer may not have access to information regarding a particular rewards program, or in some instances, the customer may view some information regarding a particular rewards program from alongside or in conjunction with information presented to the customer regarding the customer's account associated with the rewards program.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

According to embodiments of the invention a method for allocating rewards across a plurality of rewards programs, each associated with one or more accounts owned by a customer, the method includes receiving customer input indicating that one or more rewards associated with a first rewards program should be associated with a second rewards program, determining a conversion factor configured for assisting conversion of the one or more rewards from the first rewards program to the second rewards program, applying, using a processing device, the conversion factor to the one or more rewards, thereby resulting in one or more converted rewards; and associating the one or more converted rewards with the second rewards program.

In some embodiments, the method also includes initiating presentation to the customer of a rewards interface including information related to one or more rewards associated with the customer, where each of the rewards is associated with at least one customer account.

In some embodiments, the method also includes determining an event indicating one or more rewards should be applied to the first or second rewards programs has occurred and crediting the first or second rewards programs with one or more rewards based at least in part on the occurrence of the event. In some such embodiments, the event is a non-transaction event. In some such embodiments, the event is a transaction event.

In some embodiments, applying the conversion factor to the one or more rewards includes multiplying the one or more rewards by the conversion factor. In some embodiments, the method also includes retrieving the conversion factor from a table including a plurality of conversion factors.

In some embodiments, determining a conversion factor includes determining a conversion factor corresponding to a rewards program, the conversion factor configured to convert rewards associated with the rewards program into a standardized format, thereby resulting in standardized rewards. In some such embodiments, the method also includes determining a second conversion factor configured to convert standardized rewards into rewards associated with a second rewards program.

In some embodiments, the method also includes building a table including a list of entries each corresponding to a rewards program, each of the entries being associated with a first conversion factor and a second conversion factor, where the first conversion factor for each entry is configured to convert rewards associated with the entry into a standardized format, thereby resulting in standardized rewards and where the second conversion factor for each entry is configured to convert standardized rewards into rewards associated with the rewards program corresponding to the entry. In some such embodiments, the method also includes retrieving a first conversion factor from the table, where applying the conversion factor to the one or more rewards, thereby resulting in one or more converted rewards includes applying the first conversion factor to the one or more rewards, thereby resulting in a standardized reward. The method also includes retrieving a second conversion factor from the table and applying the second conversion factor to the standardized reward, thereby resulting in a converted reward.

In some embodiments, the method also includes building a table having a list of entries each corresponding to a rewards program, each of the entries being associated with a plurality of conversion factors, each of the plurality of conversion factors configured to convert rewards associated with the rewards program into rewards associated with one or more of a plurality of second rewards programs.

According to embodiments of the invention, a system allocates rewards across a plurality of rewards programs, each associated with one or more accounts owned by a customer. The system includes a processing device configured for receiving customer input indicating that one or more rewards associated with a first rewards program should be associated with a second rewards program, determining a conversion factor configured for assisting conversion of the one or more rewards from the first rewards program to the second rewards program, applying the conversion factor to the one or more rewards, thereby resulting in one or more converted rewards, and associating the one or more converted rewards with the second rewards program.

In some embodiments, the processing device is also configured for initiating presentation to the customer of a rewards interface including information related to one or more rewards associated with the customer, where each of the rewards is associated with at least one customer account.

In some embodiments, the processing device is further configured for determining an event indicating one or more rewards should be applied to the first or second rewards programs has occurred, and crediting the first or second rewards programs with one or more rewards based at least in part on the occurrence of the event. In some such embodiments, the event is a non-transaction event. In some such embodiments the event is a transaction event.

In some embodiments, applying the conversion factor to the one or more rewards includes multiplying the one or more rewards by the conversion factor. In some embodiments, the processing device is further configured for retrieving the conversion factor from a table comprising a plurality of conversion factors.

In some embodiments, determining a conversion factor includes determining a of conversion factor corresponding to a rewards program, the conversion factor configured to convert rewards associated with the rewards program into a standardized format, thereby resulting in standardized rewards. In some such embodiments, the processing device is further configured for determining a second conversion factor configured to convert standardized rewards into rewards associated with a second rewards program.

In some embodiments, the processing device is further configured for building a table including a list of entries each corresponding to a rewards program, each of the entries being associated with a first conversion factor and a second conversion factor, where the first conversion factor for each entry is configured to convert rewards associated with the entry into a standardized format, thereby resulting in standardized rewards and wherein the second conversion factor for each entry is configured to convert standardized rewards into rewards associated with the rewards program corresponding to the entry. In some such embodiments, the processing device is further configured for retrieving a first conversion factor from the table. Applying the conversion factor to the one or more rewards results in one or more converted rewards including applying the first conversion factor to the one or more rewards, thereby resulting in a standardized reward. The processing device is further configured for retrieving a second conversion factor from the table and applying the second conversion factor to the standardized reward, thereby resulting in a converted reward.

In some embodiments, the processing device is further configured for building a table comprising a list of entries each corresponding to a rewards program, each of the entries being associated with a plurality of conversion factors, each of the plurality of conversion factors configured to convert rewards associated with the rewards program into rewards associated with one or more of a plurality of second rewards programs.

According to embodiments of the invention, a computer program product includes a non-transient computer-readable memory having computer-executable instructions for allocating rewards across a plurality of rewards programs, each associated with one or more accounts owned by a customer. The instructions include instructions for receiving customer input indicating that one or more rewards associated with a first rewards program should be associated with a second rewards program, instructions for determining a conversion factor configured for assisting conversion of the one or more rewards from the first rewards program to the second rewards program, instructions for applying the conversion factor to the one or more rewards, thereby resulting in ne or more converted rewards, and instructions for associating the one or more converted rewards with the second rewards program.

In some embodiments, the instructions also include instructions for initiating presentation to the customer of a rewards interface comprising information related to one or more rewards associated with the customer, where each of the rewards is associated with at least one customer account. In some embodiments, the instructions also include instructions for determining an event indicating one or more rewards should be applied to the first or second rewards programs has occurred and instructions for crediting the first or second rewards programs with one or more rewards based at least in part on the occurrence of the event. In some such embodiments, the event is a non-transaction event. In some such embodiments, the event is a transaction event.

In some embodiments, the instructions for applying the conversion factor to the one or more rewards include instructions for multiplying the one or more rewards by the conversion factor. In some embodiments, the instructions also include instructions for retrieving the conversion factor from a table including a plurality of conversion factors. In some embodiments, the instructions for determining a conversion factor include instructions for determining a of conversion factor corresponding to a rewards program, the conversion factor configured to convert rewards associated with the rewards program into a standardized format, thereby resulting in standardized rewards. In some of these embodiments, the instructions also include instructions for determining a second conversion factor configured to convert standardized rewards into rewards associated with a second rewards program.

In some embodiments, the instructions also include instructions for building a table including a list of entries each corresponding to a rewards program, each of the entries being associated with a first conversion factor and a second conversion factor, where the first conversion factor for each entry is configured to convert rewards associated with the entry into a standardized format, thereby resulting in standardized rewards and wherein the second conversion factor for each entry is configured to convert standardized rewards into rewards associated with the rewards program corresponding to the entry. In some such embodiments, the instructions also include instructions for retrieving a first conversion factor from the table. In such embodiments, the instructions for applying the conversion factor to the one or more rewards, thereby resulting in one or more converted rewards include instructions for applying the first conversion factor to the one or more rewards, thereby resulting in a standardized reward. In such embodiments, the instructions also include instructions for retrieving a second conversion factor from the table and instructions for applying the second conversion factor to the standardized reward, thereby resulting in a converted reward.

In some embodiments, the instructions also include instructions for building a table including a list of entries each corresponding to a rewards program, each of the entries being associated with a plurality of conversion factors, each of the plurality of conversion factors configured to convert rewards associated with the rewards program into rewards associated with one or more of a plurality of second rewards programs.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIGS. 1A-1C are flowcharts illustrating a method for allocating rewards across a plurality of rewards programs, each associated with one or more accounts owned by a customer according to embodiments of the invention;

FIG. 2 is a flowchart illustrating a method for providing a customer-centric rewards platform configured to communicate to a customer information related to one or more rewards programs associated with one or more customer accounts according to embodiments of the invention;

FIG. 3 is a flowchart illustrating another method for providing a customer-centric rewards platform configured to communicate to a customer information related to one or more rewards programs associated with one or more customer accounts according to embodiments of the invention;

FIG. 4 is a flowchart illustrating optional steps for the methods discussed with reference to FIGS. 1A, 1B, 1C, 2 and 3 according to embodiments of the invention;

FIG. 5 is a block diagram of an environment wherein a system configured for performing one or more of the method steps discussed herein operates according to embodiments of the invention; and

FIGS. 6A-6D are screenshots of the customer awareness platform described herein according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

According to embodiments of the invention, a consumer awareness platform or interface provides a customer information regarding one or more rewards programs in which the customer is participating. The customer has one or more rewards accounts each part of one of the rewards programs and governed by the parameters established by the manager, such as a financial institution, merchant or other entity, of the rewards program. Each of the customer's rewards accounts is typically, but not necessarily, tied to or is associated with one of the customer's financial accounts, such as a checking, savings, credit or other account. Thus, a single customer may have many rewards accounts, associated with various rewards programs established and maintained by the programs' manager or managing institution. Each of the rewards accounts are typically, but not necessarily tied to one of the customer's accounts such that transactions effecting those accounts influence the number and/or amount of the reward issued to the rewards account. In other embodiments, non-account transaction events trigger rewards for a customer's rewards account, and in some such embodiments, such rewards accounts are not necessarily tied to one of the customer's financial accounts. The customer awareness platform provides the customer vision into the customer's entire relationship with the managing institution, such as the customer's bank or financial institution. In that regard, the customer can review and manage all of the customer's rewards accounts from a centralized platform.

According to embodiments of the invention, a method for allocating rewards across a plurality of rewards programs, each associated with one or more accounts owned by a customer, the method includes receiving customer input indicating that one or more rewards associated with a first rewards program should be associated with a second rewards program, determining a conversion factor configured for assisting conversion of the one or more rewards from the first rewards program to the second rewards program, applying, using a processing device, the conversion factor to the one or more rewards, thereby resulting in one or more converted rewards; and associating the one or more converted rewards with the second rewards program.

According to other embodiments of the invention, a method for providing a customer-centric rewards interface configured to communicate to a customer information related to one or more rewards programs associated with one or more customer accounts includes authenticating an identity of the customer, receiving customer input requesting presentation of the rewards interface, and initiating presentation, using a processing device, to the customer of the rewards interface comprising information related to one or more rewards programs associated with the customer.

According to yet other embodiments of the invention, a method for providing a customer-centric rewards platform configured to communicate to a customer information related to one or more rewards programs associated with one or more customer accounts includes initiating presentation, using a processing device, to the customer of the rewards platform comprising information related to one or more rewards programs associated with the customer, wherein each of the rewards programs is associated with at least one customer account, determining a non-account transaction event indicating one or more rewards should be applied to one or more rewards accounts has occurred, each of the one or more rewards accounts associated with one or more customer accounts, and crediting one or more rewards accounts with one or more rewards based at least in part on the occurrence of the non-account transaction event.

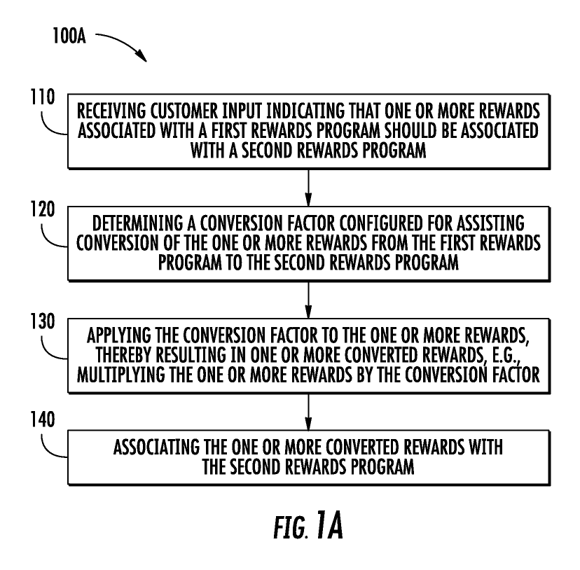

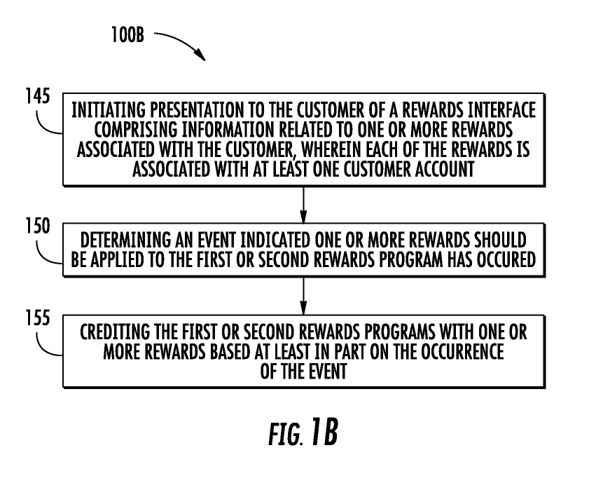

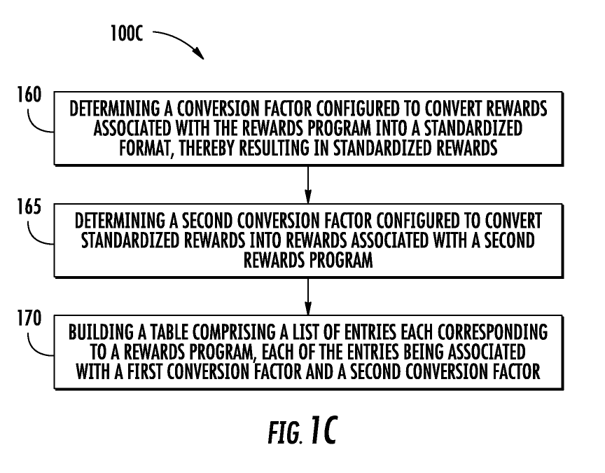

Referring now to FIG. 1A, a flowchart illustrates a method 100A for allocating rewards across a plurality of rewards programs, each associated with one or more accounts owned by a customer according to embodiments of the invention. The first step, as represented by block 110 is receiving customer input indicating that one or more rewards associated with a first rewards program should be associated with a second rewards program. In some embodiments, the system provides the customer an opportunity to convert rewards to standardized rewards and then convert the standardized rewards into rewards associated with other rewards programs. In other embodiments, the customer is simply given an option to convert from one type of rewards to anther type of rewards. That is, the customer may choose to convert from rewards associated with a first rewards program to rewards associated with another rewards program.

The next step, as represented by block 120, is determining a conversion factor configured for assisting conversion of the one or more rewards from the first rewards program to the second rewards program. In various embodiments, the conversion factors are predetermined either manually, automatically, or a combination of manual and automatic determination and then stored, such as in a table including listings of various conversion factors. In some embodiments, the conversion factors convert the rewards into standardized rewards, and in other embodiments, the conversion factors convert the rewards directly to rewards associated with other rewards programs. In various embodiments, determining the conversion factor(s) includes retrieving one or more conversion factors from a datastore housing a table as discussed above. In other embodiments, a table includes a plurality of pointers indicating a location in a datastore where the conversion factor is stored. The system uses the pointer to retrieve the appropriate conversion factor(s). In some embodiments, determining a conversion factor includes calculating a conversion factor based on one or more inputs. The inputs may include the type of rewards to be converted, the type of rewards to be the result, whether the rewards are being converted to standardized rewards and the like. In some embodiments, the conversion factors are numerical values to be applied to the rewards, such as points or cash, and in other embodiments, the conversion factors are based on an allocation amount. For example, when the rewards to be converted are related bases associated with baseball merchandise rewards program, the conversion factor may allocate one standardized point for every “base” reward accumulated by the customer. In another example, a standardized point may be considered equivalent to one hundred “bases.” In such a case, a conversion factor may be determined in order to convert the number of bases to the appropriate number of standardized points.

The next step, as represented by block 130, is applying the conversion factor to the one or more rewards, thereby resulting in one or more converted rewards. For example, in some embodiments, applying the conversion factor includes multiplying the one or more rewards by the conversion factor. As discussed above, the conversion factor may be applied to the rewards to be converted in order to determine standardized rewards or, in some embodiments, in order to determine the rewards associated with the rewards program desired by the customer.

The last step, as represented by block 140, is associating the one or more converted rewards with the second rewards program. Once the rewards have been converted by applying the conversion factor, or in some cases, multiple conversion factors, the rewards are associated with the appropriate rewards program in the appropriate rewards account of the customer. The customer awareness platform may then display the rewards now associated with the desired awards program. In some embodiments, the customer awareness platform also provides the customer information regarding rewards to rewards transactions, such as detailing the amount of rewards converted and the amount of rewards after conversion. Other information may also be provided, such as the time and date of conversion and the types of rewards converted from and to during the transaction.

Referring now to FIG. 1B, a flowchart illustrates a method 100B including method steps that are optional additions to the steps disclosed with reference to FIG. 1A. In various embodiments, some, all or none of these steps are executed in conjunction with the steps of method 100A. The first step shown, as represented by block 145, is initiating presentation to the customer of a rewards interface comprising information related to one or more rewards associated with the customer. In some embodiments, each of the rewards is associated with at least one customer account.

The next step shown, as represented by block 150, is determining an event indicating one or more rewards should be applied to the first or second rewards program has occurred. In various embodiments, the triggering event is a transaction associated with one or more of the customer's accounts wherein the customer has enrolled in a rewards program. In various other embodiments, the triggering event is a non-account transaction, such as when the customer opens a number of account above a predetermined threshold or when the customer accumulates assets over a predetermined threshold in one or more of the customer's accounts. In various other embodiments, when the customer accumulates a number of rewards in one or more rewards accounts, it is deemed a triggering event. In some embodiments, the rewards are converted to standardized rewards in order to determine whether a triggering event has occurred. For example, all the customer's rewards accounts are converted to standardized rewards and once the standardized rewards have accumulated past a predetermined threshold, then a triggering event has occurred.

The last step shown, as represented by block 160, is crediting the first or second rewards programs with one or more rewards based at least in part on the occurrence of the event. In some instances more than one rewards program and/or rewards accounts are credited based on the type of triggering event that has occurred.

Referring now to FIG. 1C, a flowchart illustrates a method 100C including method steps that are option additions to the steps disclosed with reference to FIG. 1A. In various embodiments, some, all or none of these steps are executed in conjunction with the steps of method 100A. The first step, as represented by block 160, is determining a conversion factor configured to convert rewards associated with the rewards program into a standardized format, thereby resulting in standardized rewards.

The next step, as represented by block 165, is determining a second conversion factor configured to convert standardized rewards into rewards associated with a second rewards program. In various embodiments, the first conversion factor and the second conversion factor may be related to one another. For example, in some embodiments, the first conversion factor represents an algorithm to be applied to rewards to convert to a standardized format, such as by multiplying the rewards by a predetermined number and adding an offset. In this example, when the second conversion factor is determined, it may be based solely or partially on the first conversion factor. For example, the second conversion factor may represent an algorithm to be applied to the standardized rewards to convert the rewards into a specific type of rewards. In some instances, when the standardized rewards are being converted into the rewards associated with the first conversion factor, the second conversion factor is related to the first conversion factor. In other instances, where the standardized rewards are being converted into rewards not associated with the first conversion factor, the second conversion factor is not related to the first conversion factor. For example, if the first conversion factor is used to convert rewards associated with travel points to standardized rewards, and the second conversion factor is used to convert standardized rewards to rewards associated with cash rewards corresponding to a checking account, the second conversion factor may not be related to the first conversion factor. However, in some instances, where the second conversion factor is used to convert standardized rewards associated with travel points, the second conversion factor may be related to, and in some instances based wholly or partially on the first conversion factor. In this regard, the first and second conversion factors may be inverses of one another, opposites of one another or otherwise related.

The last step shown, as represented by block 170, is building a table comprising a list of entries each corresponding to a rewards program. In some embodiments, each of the entries is associated with a first conversion factor and a second conversion factor. In various other embodiments, each entry is associated with a plurality of conversion factors, each configured to convert the rewards of the rewards program into the rewards of a plurality of different rewards programs.

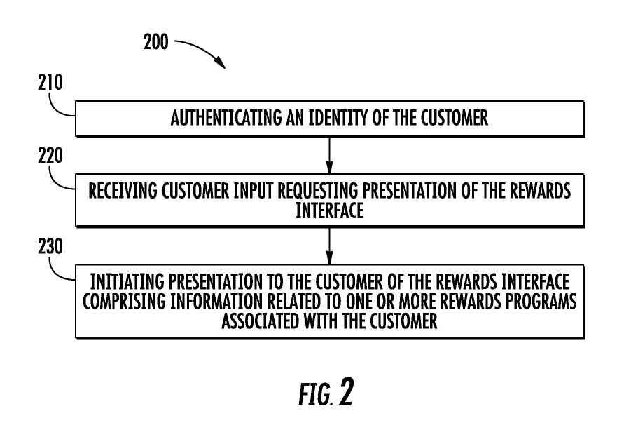

Referring now to FIG. 2, a flowchart illustrating a method 200 for providing a customer-centric rewards interface configured to communicate to a customer information related to one or more rewards programs associated with one or more customer accounts according to embodiments of the invention is shown. The first step, as represented by block 210, is authenticating an identity of the customer. Various methods for authenticating the customer may be used. In some embodiments, the same authentication that is used for an online banking customer may be used in order to gain access to the customer awareness platform. In various other embodiments, the authentication requires a different username, password, and/or other means for identification/authentication. In some instances, authentication is a multi-level process, such as one requiring a username and password as well as another level of authentication.

The next step, as represented by block 220, is receiving customer input requesting presentation of the rewards interface. In some embodiments, the customer is provided a link to the customer awareness platform from the online banking website. In some embodiments, once the customer is authenticated to the online banking website, the customer is automatically presented the rewards interface. In other embodiments, once the customer is authenticated to the online banking website, the customer is provided a popup window presenting the rewards interface. The popup window is presented so that the customer still has access to the general online banking website presenting information, for example, regarding the customer's bank accounts maintained by the financial institution. In some embodiments, the rewards interface is presented as a frame, tab or separate window within the customer's browser, either in response to the customer being authenticated by the online banking website or based on received customer input choosing a link to the rewards interface.

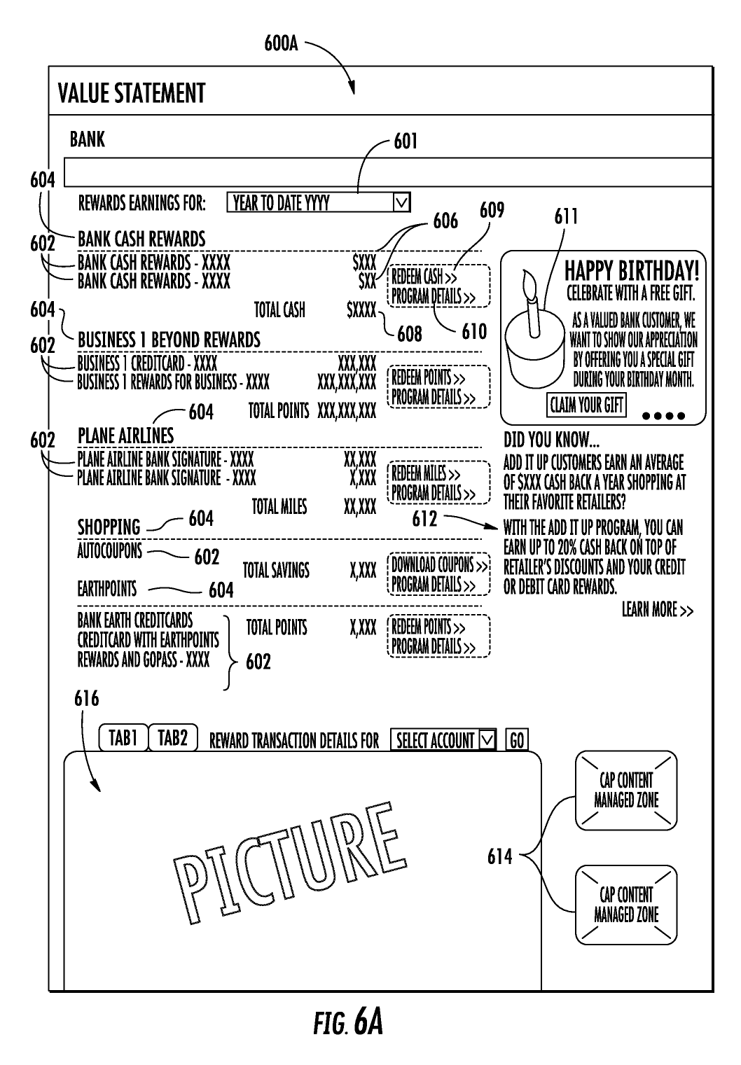

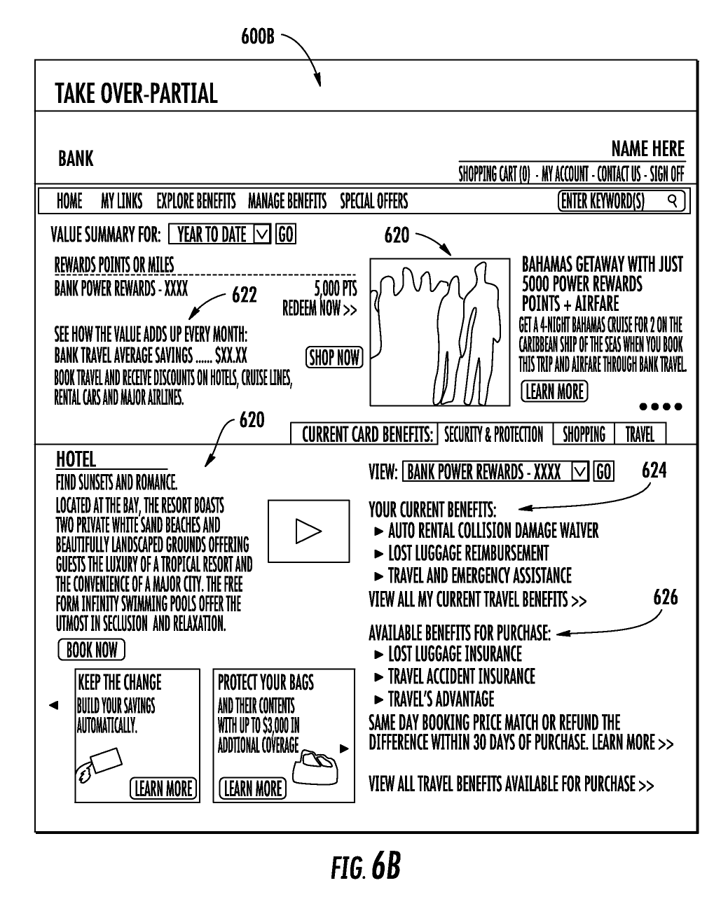

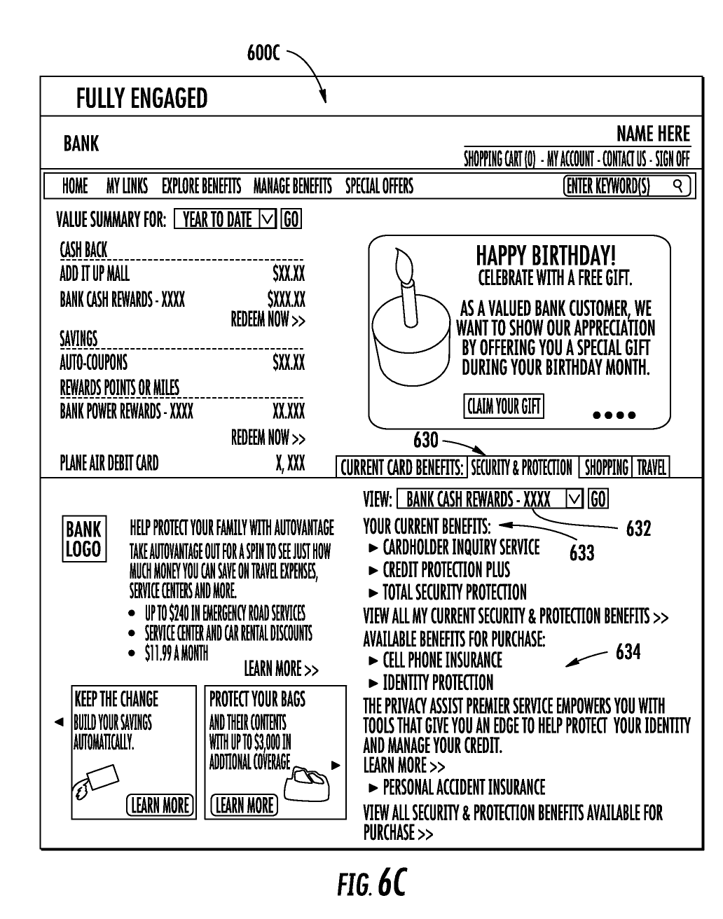

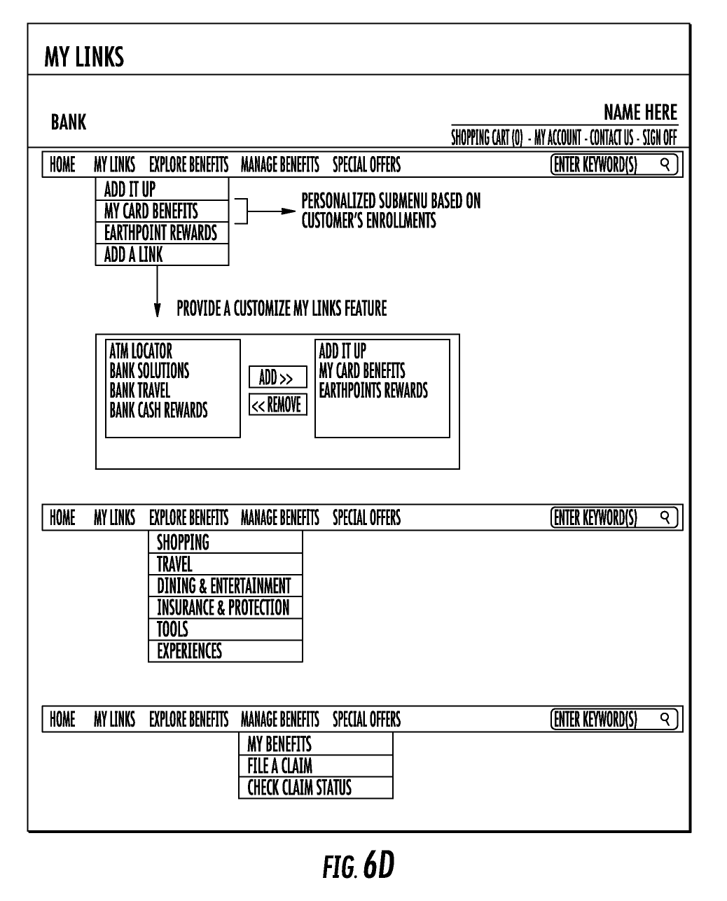

The last step, as represented by block 230, is initiating presentation to the customer of the rewards interface comprising information related to the one or more rewards programs associated with the customer. As shown in the screenshots illustrated in FIG. 6A, 6B, 6C, and 6D, various information and functions may be provided with the customer awareness platform, for example, marketing material may be provided, summaries of customer rewards may be provided, and potential goals for the customer to achieve through rewards accumulation may be provided.

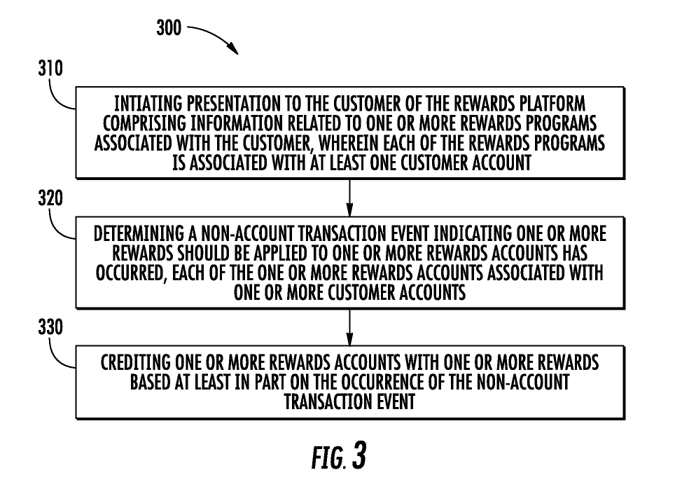

Referring now to FIG. 3, a flowchart illustrating another method 300 for providing a customer-centric rewards interface configured to communicate to a customer information related to one or more rewards programs associated with one or more customer accounts according to embodiments of the invention is shown. The first step, as represented by block 310, is initiating presentation to the customer of the rewards platform comprising information related to one or more rewards programs associated with the customer. In some embodiments, each of the rewards programs is associated with at least one customer account. In some embodiments, a rewards program is associated with more than one customer account.

The next step, as represented by block 320, is determining a non-account transaction event indicating one or more rewards should be applied to one or more rewards accounts has occurred. In some embodiments, each of the one or more rewards accounts is associated with one or more customer accounts. A non-transaction event may be or include any event not traditionally considered a transaction event and/or may be or include events related to financial activity or transaction activity but not immediately or directly related to one or more specific transactions. For example, in one instance, a customer opens a predetermined number of rewards accounts with the financial institution. In another example, the customer's total balance held by the financial institution rises above a predetermined threshold. In another example, the customer becomes a repeat customer at the financial institution for one or more products, such as a mortgage product. In another example, a customer is provided by another user as having referred the other user to the financial institution for one or more products. In another example, the customer publishes one or more messages, or a predetermined number of messages speaking highly of the financial institution or some product associated or offered by the financial institution. In another example, the customer provides feedback, positive or negative regarding some aspect of the customer's dealings with the financial institution, such as the customer's opinion regarding a specific credit card product.

The last step, as represented by block 330, is crediting one or more rewards accounts with one or more rewards based at least in part on the occurrence of the non-account transaction event. For example, in a case where a customer provides a predetermined number of feedback responses regarding financial institution products, the customer may be entitled to receive a number of rewards points credited to the customer's standardized rewards account. In such a case, the customer has the ability to move the standardized rewards points to one or more rewards accounts, for example, using the conversion steps discussed above.

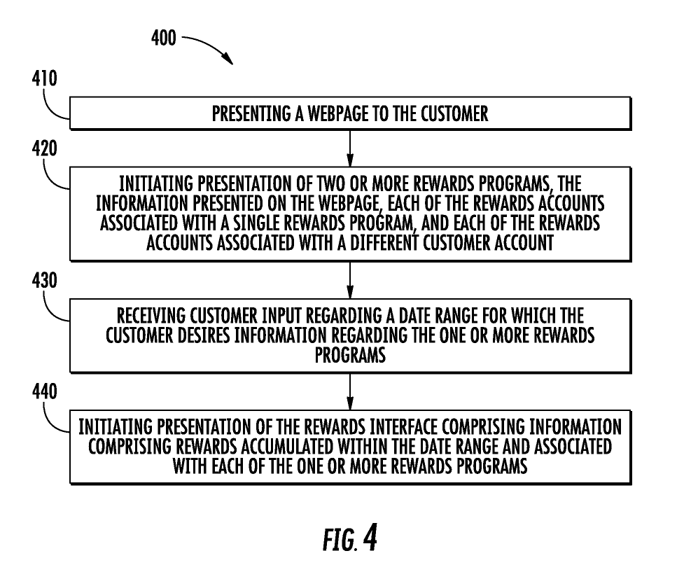

Referring now to FIG. 4, a flowchart illustrates a method 400 including method steps that are optional additions to the steps disclosed with reference to FIGS. 2 and/or 3. In various embodiments, some, all or none of these steps are executed in conjunction with the steps of method 200 and/or method 300. The first step, as represented by block 410, is presenting a webpage to the customer. As discussed above, the presentation of the webpage to the customer may take different forms, such as, for example, the presentation may be on the same webpage the customer had previously visited, the webpage may be presented in a popup, or the webpage may be presented as a tab or frame, among other presentations.

The next step, as represented by block 420, is initiating presentation of two or more rewards programs. In various embodiments, the information is presented on the webpage. In some embodiments, each of the rewards accounts is associated with a single rewards program, and each of the rewards accounts is associated with a different customer account. In various other embodiments, one or more of the rewards accounts is associated with two or more rewards programs, and in some embodiments, one or more of the rewards accounts is associated with two or more different customer accounts.

The next step, as represented by block 430, is receiving customer input regarding a date range for which the customer desires information regarding one or more of the rewards programs. The last step, as represented by block 440, is initiating presentation of the rewards interface. In various embodiments, the rewards interface includes information such as the rewards accumulated within the date range and associated with each of the one or more rewards programs. The rewards interface may also provide various other types of information such as comprehensive information related to all a customer's rewards accounts, information related to users associated with the customer via a social network, information related to the customer such as potential new rewards programs recommended for the customer based on the customer's specific interest, spending habits, transaction history or other information related to the customer and the like.

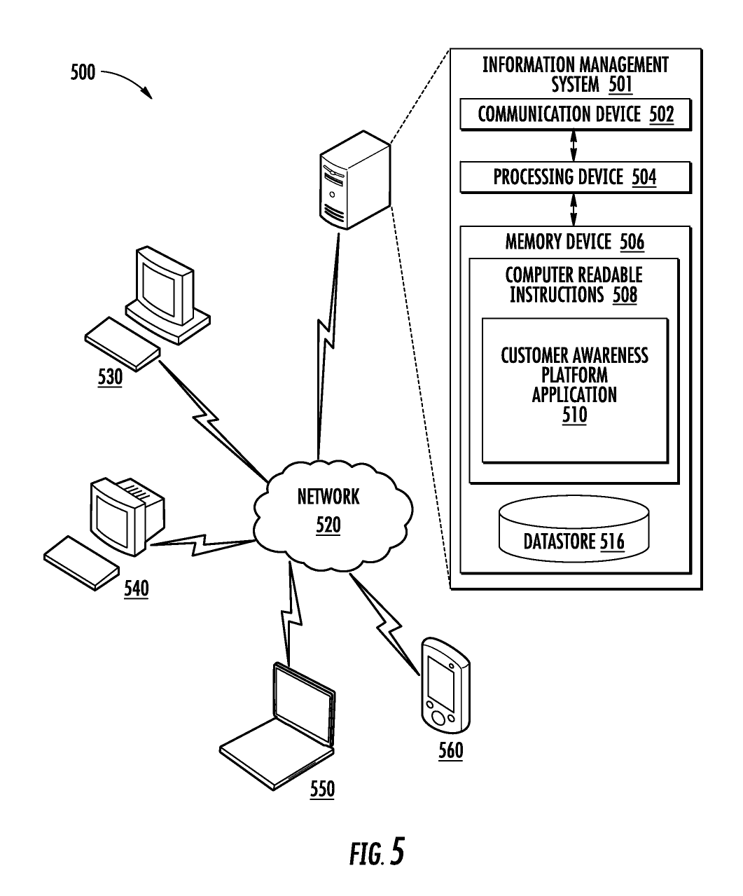

Referring now to FIG. 5, an environment 500 in which a customer awareness platform system 501 operates is illustrated. The customer awareness platform system 501 may, in various embodiments be configured for performing one or more of the methods 100A, 100B, 100C, 200, 300 and/or 400 including or excluding one or more of the various steps disclosed above. In the configuration shown, the customer awareness platform system 501 communicates across a network 520 with one or more remote devices, such as workstation 540, workstation 530, laptop 550 and/or handheld device 560. This configuration is intended to illustrate that a customer or other user (not shown) can interact with the customer awareness platform system 501 using a variety of devices remote to the customer awareness platform system 501. Furthermore, in some embodiments one or more customers can interact with the customer awareness platform system 501 locally such as through an input/output device attached directly with the customer awareness platform system 501.

The customer awareness platform system 501, in various embodiments, has a communication device 502 controlled by a processing device 504 in order to communicate across the network 520. The network 520 is an intranet, the Internet, a local area network, a wide area network, and/or any other electronic device network, and/or any combination of the same. The processing device 504 is also in communication with a memory device 506 configured for storing computer-readable and computer-executable instructions 508. The computer-readable instructions, in various embodiments, include one or more applications, such as a customer awareness platform application 510.

Generally, in some embodiments, some, all or none of the method steps and/or sub-steps discussed above with reference to FIGS. 1A, 1B, 1C, 2, 3, and/or 4 are embodied in computer-executable instructions within the customer awareness platform application 510. In some embodiments, the one or more applications are contained within one application, and in other embodiments, the instructions for executing the customer awareness platform are spread over two or more applications. In some embodiments, some of the instructions for executing the customer awareness platform are stored on the customer awareness platform system 501 and some of the instructions are stored on a customer device, such as one of the remote devices shown in FIG. 5. In some embodiments, some or all the instructions are stored remotely from the customer awareness platform system 501 and accessed as necessary by the customer awareness platform system 501 and/or any other device requiring instructions. Further, in some embodiments, the memory device 506 includes a datastore 516 configured for storing information and/or data such as the data corresponding to rewards associated with rewards accounts owned by one or more customers. In some embodiments, the datastore 516 is also configured for storing information and/or data such as one or more tables including entries associated with a plurality of rewards programs and various conversion factors as discussed above. In other embodiments, the datastore 516 is housed remotely from the customer awareness platform system 501 and the customer awareness platform system 501 is in communication with the datastore 516 across the network 520 and/or across some other communication link.

In some embodiments one or more additional systems or servers are configured for communicating with the customer awareness platform system 501. In some such embodiments, information regarding different customer may be stored in various locations on different systems. In some embodiments, information regarding one customer's financial accounts, rewards accounts, and/or rewards associated with the rewards accounts may be stored on separate systems or datastores. In some embodiments, a customer awareness platform system 501 functions as a central control server and accesses the various pieces of customer information from various locations, thereafter presenting it to the customer via the customer awareness platform. In various other embodiments, multiple servers or systems functions together as a central control server and access different pieces of data and/or instructions in order to initiate presentation of the customer awareness platform.

Referring now to FIG. 6A, a screenshot of a value statement 600A of the customer awareness platform is shown according to embodiments of the invention. As shown, a date range input field 601 is configured to receive customer input regarding a date range over which the customer desires to view information regarding the customer's rewards accounts. The customer in the example shown has many different rewards accounts 602, each associated with a particular rewards program 604. For example, one rewards program is titled a Bank Cash Rewards program, and the customer in this example has two rewards accounts associated with that particular rewards program. The customer has accumulated a cash rewards amount 606 corresponding to both of the rewards accounts, and a total cash rewards amount 608 is also presented. A link 609 to another webpage configured for redeeming the cash rewards is provided. A link 610 to another webpage configured for providing detailed information regarding the rewards program.

Similarly, other rewards programs designed for the customer to accumulate rewards in the form of points, miles, and savings are shown in the example. Total points, miles and savings are presented for the customer. Likewise, links to other webpages configured to provide details regarding redeeming the points, miles, and/or savings are provided. Program details links are also provided for each of the rewards programs.

In some embodiments, such as the one shown in FIG. 6A, a presentation 612 indicates to the customer that a gift is available to the customer. In various embodiments, the system determines whether to offer a gift to the customer based on the number and/or amount of rewards the customer has accumulated. In some embodiments, such as the one shown, a presentation provides information regarding the rewards programs for which the customer is enrolled, and in other embodiments, a presentation provides information regarding the rewards programs for which the customer is not yet enrolled. In various other embodiments, some combination of information regarding both rewards programs in which the customer is already enrolled and those which the customer is not already enrolled is provided. In some embodiments, the information provided regarding the rewards programs details the types of rewards available to the customer as well as any potential prize that can be claimed upon accumulated sufficient rewards.

In some embodiments, a content managed zone 614 is configured to deepen the relationship between the customer and the managing entity, such as the financial institution providing the various rewards programs and the customer awareness platform. The content managed zone 614 provides an area in the customer awareness platform for the managing entity to provide rewards-related offers to the customer, to raise awareness of programs the customer is qualified for or encouraged to participate in based on customer-level information. For example, if the customer has a predetermined level of assets in the customer's accounts, then the offers provided to the customer may include an offer for travel as opposed to an offer for a cash-back purchase.

In some embodiments, a rewards transactions details area 616 provides a single destination for a customer to view rewards-related transactions histories, status and the like. The customer is provided an input 618 configured to receive customer input regarding which of the customer's accounts, the customer desires rewards-related information.

In some embodiments, the value statement also provides the customer an opportunity to convert rewards from one rewards account to another rewards account. In some embodiments, as discussed above in greater detail, the value statement provides the customer an opportunity to convert rewards to standardized rewards. Then, the customer is provided an opportunity to convert the standardized rewards into rewards associated with one or more other rewards accounts associated with one or more other rewards programs.

Referring now to FIG. 6B, a screenshot of a takeover-partial screen 600B of the customer awareness platform is shown according to embodiments of the invention. In this example, a customer is provided information regarding travel in frame 620. This information is provided to the customer as targeted marketing information based at least in part on the customer's participation in a travel rewards program, as shown by listing 622. Additionally, other benefits 624 afforded the customer such as travel benefits as well as other benefits 626 available to the customer for purchase are displayed.

Referring now to FIG. 6C, a screenshot of a fully engaged screen 600C of the customer awareness platform is shown according to embodiments of the invention. Security and Protection benefits 630 are shown in this example. The customer is given an opportunity to review the present security and protection benefits 633 associated with the customer's cash rewards program account, or any other rewards account chosen by the customer by using input 632. The customer is also provided information 634 regarding additional security or protection benefits available for purchase.

Referring now to FIG. 6D, a screenshot of a mylinks page 600D of the customer awareness platform is shown according to embodiments of the invention. This page provides the customer an opportunity to customize the pages provided on the customer awareness platform. In this example, the customer is provided an opportunity to customize the links provided regarding the various rewards programs in which the customer is enrolled. In various other embodiments, additional customizable features are available, such as, for example, the customer having options regarding the types of information presented in the value statement of the customer awareness platform. In some embodiments, the customer is given an opportunity to specify which marketing materials appear in the various pages of the customer awareness platform. For example, if the customer does not desire to receive travel marketing despite the customer's enrollment in a travel rewards program, the customer may specify such a preference. On the other hand, if the customer is interested in receiving marketing materials regarding merchandise, services or travel offers that are unrelated to the rewards programs in which the customer is enrolled, the customer may specify such a preference. In such a case, the system may use such information in order to provide information regarding rewards programs related to those areas of interest expressed by the customer.

In some embodiments, the rewards interface includes not only information regarding the specific customer associated with the rewards interface, but also information regarding one or more other users, such as users within some social network of the customer. In some embodiments, the customer's family's rewards accounts are included in the customer's rewards interface. In some embodiments, presentation of other users' rewards accounts is authorized by each individual account owner, and in other instances, such as where the customer has some control over the other user(s), such as in a parent-child relationship, the customer may establish control over the other user's rewards accounts either at inception of the accounts or at some subsequent time after inception of the accounts.

In summary, according to embodiments of the invention, a method for allocating rewards across a plurality of rewards programs, each associated with one or more accounts owned by a customer, the method includes receiving customer input indicating that one or more rewards associated with a first rewards program should be associated with a second rewards program, determining a conversion factor configured for assisting conversion of the one or more rewards from the first rewards program to the second rewards program, applying, using a processing device, the conversion factor to the one or more rewards, thereby resulting in one or more converted rewards; and associating the one or more converted rewards with the second rewards program.

According to other embodiments of the invention, a method for providing a customer-centric rewards interface configured to communicate to a customer information related to one or more rewards programs associated with one or more customer accounts includes authenticating an identity of the customer, receiving customer input requesting presentation of the rewards interface, and initiating presentation, using a processing device, to the customer of the rewards interface comprising information related to one or more rewards programs associated with the customer.

According to yet other embodiments of the invention, a method for providing a customer-centric rewards platform configured to communicate to a customer information related to one or more rewards programs associated with one or more customer accounts includes initiating presentation, using a processing device, to the customer of the rewards platform comprising information related to one or more rewards programs associated with the customer, wherein each of the rewards programs is associated with at least one customer account, determining a non-account transaction event indicating one or more rewards should be applied to one or more rewards accounts has occurred, each of the one or more rewards accounts associated with one or more customer accounts, and crediting one or more rewards accounts with one or more rewards based at least in part on the occurrence of the non-account transaction event.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for allocating rewards across a plurality of rewards programs, each associated with one or more accounts owned by a customer, the method comprising:
receiving customer input indicating that one or more rewards associated with a first rewards program should be associated with a second rewards program;
determining a conversion factor configured for assisting conversion of the one or more rewards from the first rewards program to the second rewards program;
applying, using a processing device, the conversion factor to the one or more rewards, thereby resulting in one or more converted rewards; and
associating the one or more converted rewards with the second rewards program.

2. The method of claim 1, further comprising:
initiating presentation to the customer of a rewards interface comprising information related to one or more rewards associated with the customer, wherein each of the rewards is associated with at least one customer account.

3. The method of claim 1, further comprising:
determining an event indicating one or more rewards should be applied to the first or second rewards programs has occurred; and
crediting the first or second rewards programs with one or more rewards based at least in part on the occurrence of the event.

4. The method of claim 3, wherein the event is a non-transaction event.

5. The method of claim 3, wherein the event is a transaction event.

6. The method of claim 1, wherein applying the conversion factor to the one or more rewards comprises multiplying the one or more rewards by the conversion factor.

7. The method of claim 1, further comprising retrieving the conversion factor from a table comprising a plurality of conversion factors.

8. The method of claim 1, wherein determining a conversion factor comprises determining a conversion factor corresponding to a rewards program, the conversion factor configured to convert rewards associated with the rewards program into a standardized format, thereby resulting in standardized rewards.

9. The method of claim 8, further comprising determining a second conversion factor configured to convert standardized rewards into rewards associated with a second rewards program.

10. The method of claim 1, further comprising building a table comprising a list of entries each corresponding to a rewards program, each of the entries being associated with a first conversion factor and a second conversion factor, wherein the first conversion factor for each entry is configured to convert rewards associated with the entry into a standardized format, thereby resulting in standardized rewards and wherein the second conversion factor for each entry is configured to convert standardized rewards into rewards associated with the rewards program corresponding to the entry.

11. The method of claim 10, further comprising retrieving a first conversion factor from the table and wherein:
applying the conversion factor to the one or more rewards, thereby resulting in one or more converted rewards comprises applying the first conversion factor to the one or more rewards, thereby resulting in a standardized reward, the method further comprising:
retrieving a second conversion factor from the table; and
applying the second conversion factor to the standardized reward, thereby resulting in a converted reward.

12. The method of claim 1, further comprising building a table comprising a list of entries each corresponding to a rewards program, each of the entries being associated with a plurality of conversion factors, each of the plurality of conversion factors configured to convert rewards associated with the rewards program into rewards associated with one or more of a plurality of second rewards programs.

13. A system for allocating rewards across a plurality of rewards programs, each associated with one or more accounts owned by a customer, the system comprising a processing device configured for:
receiving customer input indicating that one or more rewards associated with a first rewards program should be associated with a second rewards program;
determining a conversion factor configured for assisting conversion of the one or more rewards from the first rewards program to the second rewards program;
applying the conversion factor to the one or more rewards, thereby resulting in one or more converted rewards; and
associating the one or more converted rewards with the second rewards program.

14. The system of claim 13, wherein the processing device is further configured for:
initiating presentation to the customer of a rewards interface comprising information related to one or more rewards associated with the customer, wherein each of the rewards is associated with at least one customer account.

15. The system of claim 13, wherein the processing device is further configured for:
determining an event indicating one or more rewards should be applied to the first or second rewards programs has occurred; and
crediting the first or second rewards programs with one or more rewards based at least in part on the occurrence of the event.

16. The system of claim 15, wherein the event is a non-transaction event.

17. The system of claim 15, wherein the event is a transaction event.

18. The system of claim 13, wherein applying the conversion factor to the one or more rewards comprises multiplying the one or more rewards by the conversion factor.

19. The system of claim 13, wherein the processing device is further configured for retrieving the conversion factor from a table comprising a plurality of conversion factors.

20. The system of claim 13, wherein determining a conversion factor comprises determining a of conversion factor corresponding to a rewards program, the conversion factor configured to convert rewards associated with the rewards program into a standardized format, thereby resulting in standardized rewards.

21. The system of claim 20, wherein the processing device is further configured for determining a second conversion factor configured to convert standardized rewards into rewards associated with a second rewards program.

22. The system of claim 13, wherein the processing device is further configured for building a table comprising a list of entries each corresponding to a rewards program, each of the entries being associated with a first conversion factor and a second conversion factor, wherein the first conversion factor for each entry is configured to convert rewards associated with the entry into a standardized format, thereby resulting in standardized rewards and wherein the second conversion factor for each entry is configured to convert standardized rewards into rewards associated with the rewards program corresponding to the entry.

23. The system of claim 22, wherein the processing device is further configured for retrieving a first conversion factor from the table and wherein:
applying the conversion factor to the one or more rewards, thereby resulting in one or more converted rewards comprises applying the first conversion factor to the one or more rewards, thereby resulting in a standardized reward, and wherein the processing device is further configured for:
retrieving a second conversion factor from the table; and
applying the second conversion factor to the standardized reward, thereby resulting in a converted reward.

24. The system of claim 13, wherein the processing device is further configured for building a table comprising a list of entries each corresponding to a rewards program, each of the entries being associated with a plurality of conversion factors, each of the plurality of conversion factors configured to convert rewards associated with the rewards program into rewards associated with one or more of a plurality of second rewards programs.

25. A computer program product comprising a non-transient computer-readable memory comprising computer-executable instructions for allocating rewards across a plurality of rewards programs, each associated with one or more accounts owned by a customer, the instructions comprising:
instructions for receiving customer input indicating that one or more rewards associated with a first rewards program should be associated with a second rewards program;
instructions for determining a conversion factor configured for assisting conversion of the one or more rewards from the first rewards program to the second rewards program;
instructions for applying the conversion factor to the one or more rewards, thereby resulting in one or more converted rewards; and
instructions for associating the one or more converted rewards with the second rewards program.

26. The computer program product of claim 25, wherein the instructions further comprise:
instructions for initiating presentation to the customer of a rewards interface comprising information related to one or more rewards associated with the customer, wherein each of the rewards is associated with at least one customer account.

27. The computer program product of claim 25, wherein the instructions further comprise:
instructions for determining an event indicating one or more rewards should be applied to the first or second rewards programs has occurred; and
instructions for crediting the first or second rewards programs with one or more rewards based at least in part on the occurrence of the event.

28. The computer program product of claim 27, wherein the event is a non-transaction event.

29. The computer program product of claim 27, wherein the event is a transaction event.

30. The computer program product of claim 25, wherein the instructions for applying the conversion factor to the one or more rewards comprise instructions for multiplying the one or more rewards by the conversion factor.

31. The computer program product of claim 25, wherein the instructions further comprise instructions for retrieving the conversion factor from a table comprising a plurality of conversion factors.

32. The computer program product of claim 25, wherein the instructions for determining a conversion factor comprise instructions for determining a of conversion factor corresponding to a rewards program, the conversion factor configured to convert rewards associated with the rewards program into a standardized format, thereby resulting in standardized rewards.

33. The computer program product of claim 32, wherein the instructions further comprise instructions for determining a second conversion factor configured to convert standardized rewards into rewards associated with a second rewards program.

34. The computer program product of claim 25, wherein the instructions further comprise instructions for building a table comprising a list of entries each corresponding to a rewards program, each of the entries being associated with a first conversion factor and a second conversion factor, wherein the first conversion factor for each entry is configured to convert rewards associated with the entry into a standardized format, thereby resulting in standardized rewards and wherein the second conversion factor for each entry is configured to convert standardized rewards into rewards associated with the rewards program corresponding to the entry.

35. The computer program product of claim 34, wherein the instructions further comprise instructions for retrieving a first conversion factor from the table and wherein:
the instructions for applying the conversion factor to the one or more rewards, thereby resulting in one or more converted rewards comprise instructions for applying the first conversion factor to the one or more rewards, thereby resulting in a standardized reward, the instructions further comprising:
instructions for retrieving a second conversion factor from the table; and
instructions for applying the second conversion factor to the standardized reward, thereby resulting in a converted reward.

36. The computer program product of claim 25, wherein the instructions further comprise instructions for building a table comprising a list of entries each corresponding to a rewards program, each of the entries being associated with a plurality of conversion factors, each of the plurality of conversion factors configured to convert rewards associated with the rewards program into rewards associated with one or more of a plurality of second rewards programs.
